(19) United States
(12) Patent Application Publication
(10) Pub. No.: US 2008/0313023 A1
(43) Pub. Date: Dec. 18, 2008

(54) System For Facilitating Objective Evaluation Of The Performance Of Sell-Side Professionals

(76) Inventor: Phillip Randal Cass, Toronto (CA)

Correspondence Address: ST. ONGE STEWARD JOHNSTON & REENS, LLC, 986 BEDFORD STREET, STAMFORD, CT, 06905-5619, US

(21) Appl. No.: 11/762,559

(22) Filed: Jun. 13, 2007

(51) Int. Cl. G06Q 10/00; G06Q 40/00

(52) U.S. Cl. 705/11

(57) ABSTRACT

A system for facilitating evaluation, by a buy-side professional, of performance of a sell-side professional, includes a computer system and a source of performance data in which the computer system is in communication. Software executing on the computer system receives from the sell-side professional a plurality of sell-side data and determines a performance evaluation of each of the sell-side data based at least in part upon contents of each of the sell-side data and at least in part upon the performance data. Software executing on the computer system also receives from the buy-side professional a set of weighted preferences indicative of importance to the buy-side professional of performance of different types of sell-side data, and calculates a performance rating of the sell-side professional based at least in part upon the performance evaluation of each of the sell-side data and at least in part upon the weighted preferences.

### FIELD OF THE INVENTION

The present invention relates generally to a system which increases accountability, disclosure and transparency in the relationships between buy-side professionals and sell-side professionals in the financial services industry, and more particularly to a system which facilitates the objective evaluation, by buy-side professionals, of the performance of sell-side professionals with whom they do or may do business.

### BACKGROUND OF THE INVENTION

The investment industry has been shaken, too often, by scandals that have eroded the trust of investors, with the conflicts of interest over recent research scandals and market timing scandals being only two examples. When looking at the dollar amounts involved in these scandals, they pale in comparison to the issue of soft dollars. It is estimated that, on average, $9 billion is paid from the buy-side to the sell-side annually for bundled services.

Bundled services include trade ideas, research reports, meetings and telephone calls with management, time and effort and entertainment, including such things as golf tournaments, dinners and other outings. This $9 billion in question is money that belongs to the investors of the buy-side's products, not the buy-side professionals themselves. So, it is not surprising that over the last few years, regulatory bodies, including the SEC, OSC and FSA have started to look very carefully at this issue.

Money managers can not afford the headline risk of spending their investors' money without being able to show the value received through the services purchased. However, it is currently extremely difficult to determine the value of such services received from the sell-side professionals, and there currently exists no adequate system for facilitating this determination. Thus, subjectivity and informality can, undesirably, influence where investor dollars are directed.

Not only does this lead to the risk of conflicts of interest, but also to the potential for actual inefficiencies. What may seem like a reasonable commission being paid to sell-side professions based upon purely subjective criteria, may be viewed as clearly unreasonable if the buy-side professional is able to objectively evaluate the true costs and actual value of currently “free” bundled services. Moreover, whereas decisions concerning which sell-side professionals with whom to do business are currently made based upon subjective criteria, such as personality, historical relationships, etc., it would be far more desirable if buy-side professionals could compare sell-side professionals based upon objective criteria, and award business to those sell-side professionals who provide services that are actually of value to the buy-side professional making the decision, and to those sell-side professionals who have a history of success. If the buy-side professional were provided with an easy comparison between sell-side professionals, the buy-side professionals could make better and more informed decisions as to which sell-side professionals to use, and how much the sell-side professionals should be compensated.

At the same time, it should be recognized that the measurements described above, while desirable, are extremely difficult to make, and are necessarily based upon huge amounts of data. It should also be recognized that the focus of the buy-side professionals must remain on generating value and lowering costs for their investors, and not on increasing the amount of “paper work” with which the buy-side professionals are already faced. Thus, any system should be simple to use, and not place significant additional burdens on the buy-side professionals themselves. Moreover, the system should continuously monitor and update the evaluations, since the value of services provided by sell-side investors may change on a daily, or even hourly, basis.

What is desired, therefore, is a system which facilitates the evaluation, by buy-side professionals, of the performance of sell-side professionals with whom they do or may do business, which facilitates a determination of a value of bundled services buy-side professionals receive from sell-side professionals, which increases accountability, disclosure and transparency in the relationships between buy-side and sell-side professionals, which is based upon objective criteria, which facilitates a determination by buy-side professionals of which sell-side professionals with whom to do business, which facilitates a determination by buy-side professionals of how much sell-side professionals should be compensated, which is simple to use and does not place significant additional burdens on the buy-side professionals, and which continuously monitors and updates the evaluations of sell-side professionals.

### SUMMARY OF THE INVENTION

Accordingly, it is an object of the present invention to provide a system which facilitates the evaluation, by buy-side professionals, of the performance of sell-side professionals with whom they do or may do business.

Another object of the present invention is to provide a system having the above characteristics and which facilitates a determination of a value of bundled services buy-side professionals receive from sell-side professionals.

A further object of the present invention is to provide a system having the above characteristics and which increases accountability, disclosure and transparency in the relationships between buy-side and sell-side professionals.

Still another object of the present invention is to provide a system having the above characteristics and which is based upon objective criteria.

Yet a further object of the present invention is to provide a system having the above characteristics and which facilitates a determination by buy-side professionals of which sell-side professionals with whom to do business.

It is also an object of the present invention is to provide a system having the above characteristics and which facilitates a determination by buy-side professionals of how much sell-side professionals should be compensated.

It is another object of the present invention is to provide a system having the above characteristics and which is simple to use and does not place significant additional burdens on the buy-side professionals.

A still further object of the present invention is to provide a system having the above characteristics and which continuously monitors and updates the evaluations of sell-side professionals.

These and other objects of the present invention are achieved, in accordance with one embodiment of the present invention, by provision of a system for facilitating evaluation, by a buy-side professional, of performance of a sell-side professional, including a computer system and a source of performance data in which the computer system is in communication. Software executing on the computer system receives from the sell-side professional a plurality of sell-side data and determines a performance evaluation of each of the plurality of sell-side data based at least in part upon contents of each of the plurality of sell-side data and at least in part upon the performance data. Software executing on the computer system also receives from the buy-side professional a set of weighted preferences indicative of importance to the buy-side professional of performance of different types of sell-side data, and calculates a performance rating of the sell-side professional based at least in part upon the performance evaluation of each of the plurality of sell-side data and at least in part upon the set of weighted preferences.

In some embodiments, the system further includes software executing on the computer system for displaying the performance rating to the buy-side professional. In certain of these embodiments, the software executing on the computer system for displaying the performance rating to the buy-side professional simultaneously displays performance ratings calculated for a plurality of sell-side professionals in order to facilitate comparison of the performance of the plurality of sell-side professionals by the buy-side professional. In certain embodiments, the software executing on the computer system for displaying the performance rating to the buy-side professional displays a comparison of the performance rating of the sell-side professional with calculated performance ratings of a plurality of other sell-side professionals comprising a universe of alternatives available for coverage.

In some embodiments, at least some of the sell-side data comprise proposed trade ideas. In certain of these embodiments, at least some of the performance data comprise data indicative of what at least one of the following would have been had each of the proposed trade ideas been implemented by the buy-side professional: relative return, risk adjusted relative return, absolute return, risk adjusted absolute return, and maximum drawdown. In these embodiments, the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown. In certain embodiments, at least some of the performance data comprise data indicative of at least one of the following: trade uniqueness, trade focus, and concentration of returns. In these embodiments, the set of weighted preferences is indicative of importance to the buy-side professional of at least one of the following: trade uniqueness, trade focus, and concentration of returns. In certain embodiments, at least some of the proposed trade ideas comprise proposed trade ideas implemented by the buy-side professional, and at least some of the proposed trade ideas comprise proposed trade ideas not implemented by the buy-side professional.

In some embodiments, at least some of the sell-side data comprise proposed meetings or calls. In certain of these embodiments, at least some of the performance data comprise data indicative of whether each of the proposed meetings or calls was accepted or declined by the buy-side professional, and the set of weighted preferences is indicative of importance to the buy-side professional of whether each of the proposed meetings or calls was accepted or declined by the buy-side professional. In certain embodiments, at least some of the performance data comprise data indicative of a quality of each of the proposed meetings or calls, and the set of weighted preferences is indicative of importance to the buy-side professional of the quality of each of the proposed meetings or calls.

In some embodiments, at least some of the sell-side data comprise research. In certain of these embodiments, at least some of the performance data comprise data indicative of a quantity of the research, and the set of weighted preferences is indicative of importance to the buy-side professional of the quantity of the research. In certain embodiments, at least some of the performance data comprise data indicative of a quality of the research, and the set of weighted preferences is indicative of importance to the buy-side professional of the quality of the research.

In some embodiments, the computer system includes a central computer, a buy-side computer, operable by the buy-side professional, in communication with the central computer over a first network, and a sell-side computer, operable by the sell-side professional, in communication with the central computer over a second network. In certain of these embodiments, at least one of the first network and the second network comprises the Internet.

In accordance with another embodiment of the present invention, a system for facilitating evaluation, by a buy-side professional, of performance of a sell-side professional, includes a central computer, a buy-side computer, operable by the buy-side professional, in communication with the central computer over a first network, a sell-side computer, operable by the sell-side professional, in communication with the central computer over a second network, and a source of performance data in which the central computer is in communication. Software executing on the central computer receives from the sell-side computer a plurality of sell-side data, each of the plurality of sell-side data comprising at least one of the following: proposed trade ideas, proposed meetings or calls and research. Software executing on the central computer determines a performance evaluation of each of the plurality of sell-side data based at least in part upon contents of each of the plurality of sell-side data and at least in part upon the performance data. Software executing on the central computer receives from the buy-side computer a set of weighted preferences indicative of importance to the buy-side professional of performance of different types of sell-side data, calculates a performance rating of the sell-side professional based at least in part upon the performance evaluation of each of the plurality of sell-side data and at least in part upon the set of weighted preferences, and transmits the performance rating to the buy-side computer for display to the buy-side professional.

In some embodiments, the software executing on the central computer for transmitting the performance rating to the buy-side computer transmits performance ratings calculated for a plurality of sell-side professionals for simultaneous display to the buy-side professional in order to facilitate comparison of the performance of the plurality of sell-side professionals by the buy-side professional. In some embodiments, the software executing on the central computer for transmitting the performance rating to the buy-side computer transmits a comparison of the performance rating of the sell-side professional with calculated performance ratings of a plurality of other sell-side professionals comprising a universe of alternatives available for coverage.

In some embodiments, at least some of the performance data comprise data indicative of what at least one of the following would have been had each of the proposed trade ideas been implemented by the buy-side professional: relative return, risk adjusted relative return, absolute return, risk adjusted absolute return, and maximum drawdown. In these embodiments, the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown. In some embodiments, at least some of the performance data comprise data indicative of at least one of the following: trade uniqueness, trade focus, and concentration of returns. In these embodiments, the set of weighted preferences is indicative of importance to the buy-side professional of at least one of the following: trade uniqueness, trade focus, and concentration of returns. In some embodiments, at least some of the proposed trade ideas comprise proposed trade ideas implemented by the buy-side professional, and at least some of the proposed trade ideas comprise proposed trade ideas not implemented by the buy-side professional.

In some embodiments, at least some of the performance data comprise data indicative of whether each of the proposed meetings or calls was accepted or declined by the buy-side professional, and the set of weighted preferences is indicative of importance to the buy-side professional of whether each of the proposed meetings or calls was accepted or declined by the buy-side professional. In some embodiments, at least some of the performance data comprise data indicative of a quality of each of the proposed meetings or calls, and the set of weighted preferences is indicative of importance to the buy-side professional of the quality of each of the proposed meetings or calls.

In some embodiments, at least some of the performance data comprise data indicative of a quantity of the research, and the set of weighted preferences is indicative of importance to the buy-side professional of the quantity of the research. In some embodiments, at least some of the performance data comprise data indicative of a quality of the research, and the set of weighted preferences is indicative of importance to the buy-side professional of the quality of the research. In some embodiments, at least one of the first network and the second network comprises the Internet.

In accordance with another aspect of the present invention, a method for facilitating evaluation, by a buy-side professional, of performance of a sell-side professional, includes the steps of: (i) receiving a plurality of sell-side data from the sell-side professional; (ii) receiving performance data from a source of performance data; (iii) determining a performance evaluation of each of the plurality of sell-side data based at least in part upon contents of each of the plurality of sell-side data and at least in part upon the performance data; (iv) receiving from the buy-side professional a set of weighted preferences indicative of importance to the buy-side professional of performance of different types of sell-side data; and (v) calculating a performance rating of the sell-side professional based at least in part upon the performance evaluation of each of the plurality of sell-side data and at least in part upon the set of weighted preferences.

In some embodiments, the method further includes the step of displaying the performance rating to the buy-side professional. In certain of these embodiments, the step of displaying the performance rating to the buy-side professional comprises the step of simultaneously displaying performance ratings calculated for a plurality of sell-side professionals in order to facilitate comparison of the performance of the plurality of sell-side professionals by the buy-side professional. In certain embodiments, the step of displaying the performance rating to the buy-side professional comprises the step of displaying a comparison of the performance rating of the sell-side professional with calculated performance ratings of a plurality of other sell-side professionals comprising a universe of alternatives available for coverage.

In some embodiments, at least some of the sell-side data comprise proposed trade ideas. In certain of these embodiments, at least some of the performance data comprise data indicative of what at least one of the following would have been had each of the proposed trade ideas been implemented by the buy-side professional: relative return, risk adjusted relative return, absolute return, risk adjusted absolute return, and maximum drawdown. In these embodiments, the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown. In some embodiments, at least some of the performance data comprise data indicative of at least one of the following: trade uniqueness, trade focus, and concentration of returns. In these embodiments, the set of weighted preferences is indicative of importance to the buy-side professional of at least one of the following: trade uniqueness, trade focus, and concentration of returns. In certain embodiments, at least some of the proposed trade ideas comprise proposed trade ideas implemented by the buy-side professional, and at least some of the proposed trade ideas comprise proposed trade ideas not implemented by the buy-side professional.

In some embodiments, at least some of the sell-side data comprise proposed meetings or calls. In certain of these embodiments, at least some of the performance data comprise data indicative of whether each of the proposed meetings or calls was accepted or declined by the buy-side professional, and the set of weighted preferences is indicative of importance to the buy-side professional of whether each of the proposed meetings or calls was accepted or declined by the buy-side professional. In some embodiments, at least some of the performance data comprise data indicative of a quality of each of the proposed meetings or calls, and the set of weighted preferences is indicative of importance to the buy-side professional of the quality of each of the proposed meetings or calls.

In some embodiments, at least some of the sell-side data comprise research. In certain of these embodiments, at least some of the performance data comprise data indicative of a quantity of the research, and the set of weighted preferences is indicative of importance to the buy-side professional of the quantity of the research. In certain of these embodiments, at least some of the performance data comprise data indicative of a quality of the research, and the set of weighted preferences is indicative of importance to the buy-side professional of the quality of the research.

The invention and its particular features and advantages will become more apparent from the following detailed description considered with reference to the accompanying drawings.

### BRIEF DESCRIPTION OF THE DRAWINGS

FIG. 1 is schematic view illustrating a system for facilitating evaluation, by a buy-side professional, of performance of a sell-side professional in accordance with an embodiment of the present invention;

FIG. 2 is a schematic flow chart illustrating a method for facilitating evaluation, by a buy-side professional, of performance of a sell-side professional in accordance with an embodiment of the present invention, which method may be performed by the system of FIG. 1; and

FIG. 3 is screen shot illustrating input of a buy-side professional's weighted preferences employing the system of FIG. 1.

### DETAILED DESCRIPTION OF AN EMBODIMENT OF THE INVENTION

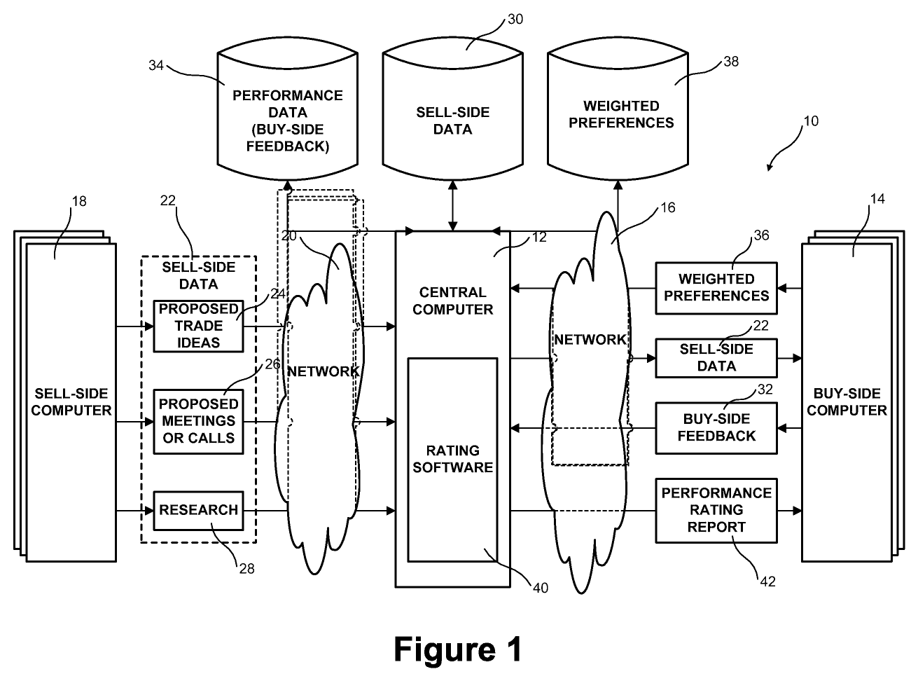

Referring first to FIG. 1, a system 10 for facilitating evaluation, by a buy-side professional, of performance of a sell-side professional in accordance with an embodiment of the present invention is shown. The system 10 includes a central computer 12 a buy-side computer 14, operable by the buy-side professional, in communication with central computer 12 over a first network 16 and a sell-side computer 18, operable by the sell-side professional, in communication with central computer 12 over a second network 20.

Networks 16, 20, may comprise any known or yet to be developed communications networks, such as the Internet, local area networks, wide area networks, virtual private networks, or any combinations thereof, although the Internet is presently preferred. When such is the case, buy-side computer 14 and sell-side computer 18 may interface with central computer 12 via a web browser or the like, or one or both of buy-side computer 14 and sell-side computer 18 may have a dedicated software application installed thereon. As shown in FIG. 1, system 10 may comprise a plurality of buy-side computers 14 operable by a plurality of buy-side professionals and/or a plurality of sell-side computers 18 operable by a plurality of sell-side professionals.

Central computer 14 receives from sell-side computer 18 a plurality of sell-side data 22, which have traditionally been regarded as comprising part of the “bundled services” provided by sell-side professionals to buy-side professionals. One type of such sell-side data 22 may be proposed trade ideas 24. Proposed trade ideas generally comprise proposed trades that the sell-side professional believes would be profitable for the buy-side professional to execute. These trade ideas may comprise a variety of types of information, such as whether the proposal is for buying or selling, an indication of the type of trade (e.g., a long trade, a short trade, a hedge trade), information about the financial instrument itself, information concerning why the sell-side professional recommends the trade, an indication of the sell-side professional's conviction concerning the proposal, etc.

Another type of sell-side data 22 may be proposed meetings or calls 26. As the name suggests, proposed meetings or calls 26 may comprise a proposal for various types of meetings or calls, such as a personal meeting, a conference call, an analyst meeting, a company meeting, a company call, an analyst call, other types of conferences, etc. The proposed meetings or calls 26 preferably also includes other information concerning the proposal, such as the proposed time/date/place of the meeting or call, the persons proposed to be involved, the company represented in the meeting (where applicable), etc.

A third type of sell-side data 22 may be research 28. Research 28 may comprise, for example, information about certain companies, sectors, markets, exchanges, or virtually any other type of research information that a sell-side professional believes may be of interest to a buy-side professional. Research 28 may be unsolicited, or may be provided in response to a specific request from the buy-side professional.

Sell-side data 22 are received by central computer 12, and forwarded to buy-side computer 14 for viewing and consideration by the buy-side professional. Sell-side data 22 may also be stored in sell-side data storage 30, which may comprise a database or some other type of storage device.

After the buy-side professional has reviewed and considered each of the sell-side data 22, the buy-side professional provides, through buy-side computer 14, buy-side feedback 32. The specific contents of each buy-side feedback 32 may vary, primarily depending upon the type of sell-side data 22 to which it relates. For example, where the sell-side data 22 comprises a proposed trade idea 24, the related buy-side feedback 32 may comprise an indication, for example, of whether or not the proposed trade idea 24 was implemented, the buy-side professional's impression of the quality of the proposed trade idea 24, the uniqueness of the proposed trade idea 24, etc. Where the sell-side data 22 comprises a proposed meeting or call 26, the related buy-side feedback 32 may comprise an indication, for example, of whether or not the proposed meeting or call 26 was accepted, the buy-side professional's impression of the quality of the proposed meeting or call 26, etc. Similarly, where the sell-side data 22 comprises research 28, the related buy-side feedback 32 may comprise an indication, for example, of whether or not the buy-side professional read the research 28, the buy-side professional's impression of the quality of the research 28, etc.

Buy-side feedback 32 is received by central computer 12 and stored in performance data storage 34, which may comprise a database or some other type of storage device. Also stored on performance data storage 34 is market data, such as historical price information for various exchanges, sufficient to allow system 10 to determine how proposed trades would have performed had they been implemented (as discussed more fully below). Buy-side feedback 32 may also be forwarded to sell-side computer 18 for viewing by the sell-side professional, although such is not required and not shown in FIG. 1.

Also received by central computer 12 is an indication of weighted preferences 36 entered by the buy-side professional using buy-side computer 14. Preferably, weighted preferences are stored in weighted preferences storage 38, which may comprise a database or some other type of storage device.

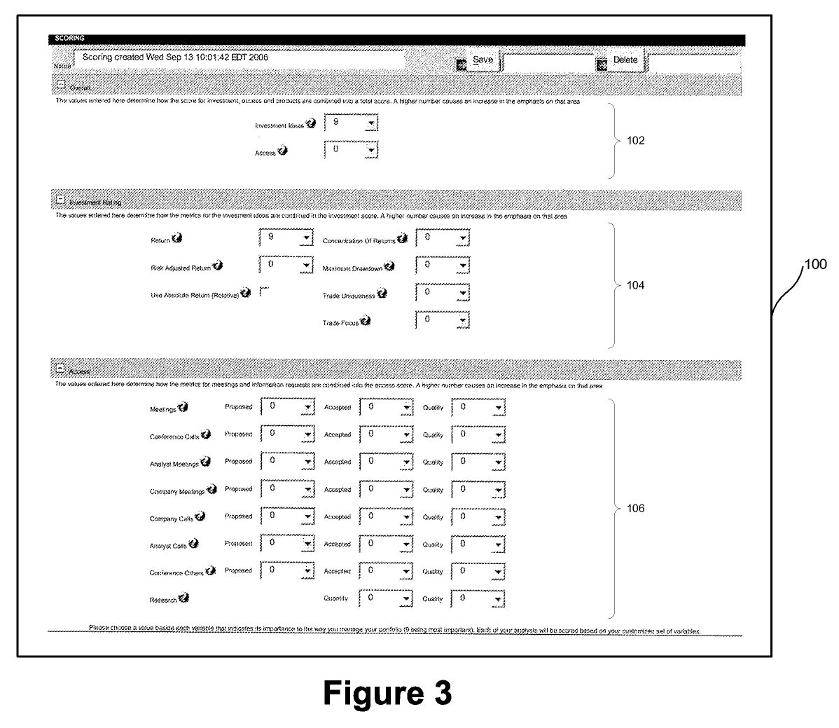

The weighted preferences 36 are indicative of importance to the buy-side professional of performance of different types of sell-side data 22, and even various aspects thereof. Referring now to FIG. 3, a screen shot 100 illustrating input of a buy-side professional's weighted preferences 36 is shown. In this example, different types of sell-side data 22 and various aspects thereof each have associated therewith a drop-down selection, raging from 0-9 (0 being not important at all, and 9 being highly important), from which the buy-side professional may select.

In portion 102 of screenshot 100 rankings may be entered for overall types of sell-side data 22, in this case for investment ideas (corresponding to proposed trade ideas 24) and access (corresponding to a combination of proposed meetings or calls 26 and research 28).

In portion 104 of screenshot 100, various aspects of proposed trade ideas 24 are broken down further to provide greater preference flexibility to buy-side investor. Drop-down selections are provided for allowing buy-side investor to rank the importance of what return, risk adjusted return, and maximum drawdown would have been had the proposed investment ideas been implemented, as are drop-down selections for allowing the buy-side investor to rank the importance of trade uniqueness, trade focus, and concentration of returns. A selection box is also provided to allow the buy-side investor to indicate whether he/she prefers that calculations be performed using absolute returns or returns relative to a specified index.

In portion 106 of screenshot 100, various aspects of proposed meetings or calls 26 and research 28 are broken down further to provide greater preference flexibility to buy-side investor. With respect to proposed meetings or calls 26, drop-down selections are provided for allowing buy-side investor to rank the importance of, for each type of proposed meetings or calls 26 (e.g., personal meetings, conference calls, analyst meetings, company meetings, company calls, analyst calls, and other types of conferences), the number of meetings or calls proposed, the number of meetings or calls accepted, and the quality of the meetings or calls. With respect to research 28, drop-down selections are provided for allowing buy-side investor to rank the importance of the quantity of research provided and the quality of the research provided.

Rating software 40 executing on central computer 12 determines a performance evaluation of each of sell-side data 22 based upon contents of each of the sell-side data 22 and upon the performance data, and then calculates a performance rating of the sell-side professional based upon the performance evaluation of each of the sell-side data 22 and upon the set of weighted preferences 36. Rating software then transmits a performance rating report 42 containing the calculated performance rating to buy-side computer 14 for display to the buy-side professional. Preferably, rating report 42 includes performance ratings calculated for a plurality of sell-side professionals for simultaneous display to the buy-side professional in order to facilitate comparison of the performance of the plurality of sell-side professionals by the buy-side professional. Preferably, rating report 42 also includes a comparison of the performance rating of the sell-side professional with calculated performance ratings of a plurality of other sell-side professionals comprising a universe of alternatives available for coverage.

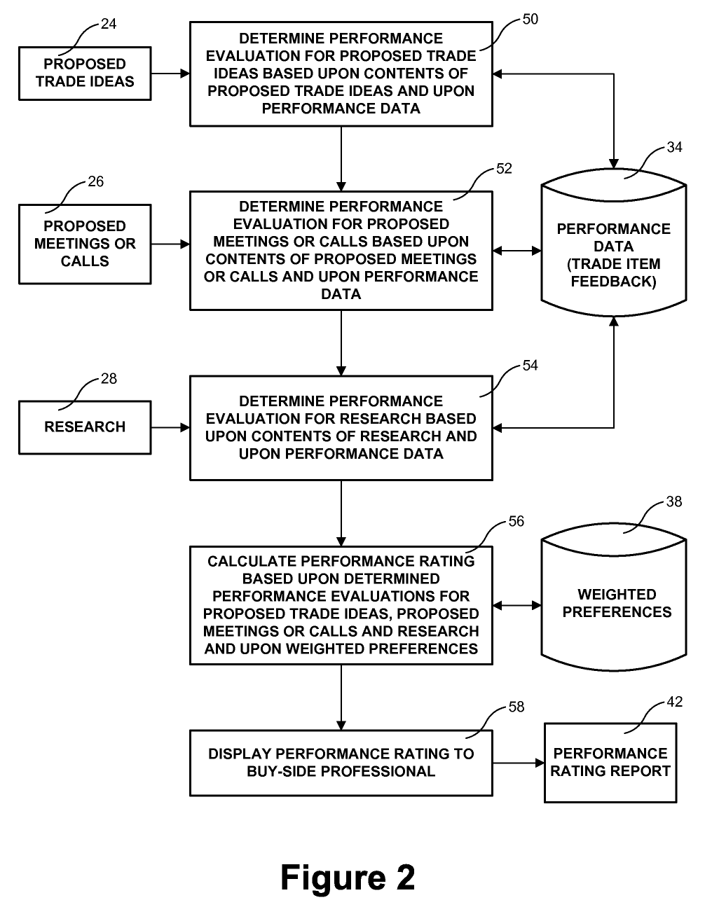

Referring now to FIG. 2, operation of an exemplary embodiment of rating software 40 is shown. As shown at block 50, rating software 40 receives proposed trade idea 24, either directly from sell-side computer 18 or from sell-side data storage 30, as well as performance data, for example from performance data storage 34, and then determines a performance evaluation for proposed trade idea 24 based upon the contents of proposed trade idea 24 and upon the performance data. The performance evaluation is preferably a series of quantified numerical values calculated by the software for each of the various aspects of the proposed trade idea 24 discussed above (e.g., return, risk adjusted return, concentration of returns, maximum drawdown, trade uniqueness, trade focus, etc.). A virtually infinite number of algorithms are possible, and many are already are known in the art, for generating quantified performance evaluations, and therefore, such algorithms are not discussed herein in detail.

Similarly, as shown at blocks 52 and 54, rating software 40 receives proposed meetings or calls 26 and research 28, either directly from sell-side computer 18 or from sell-side data storage 30, as well as performance data, for example from performance data storage 34, and then determines performance evaluations for proposed meetings or calls 26 and research 28 based upon the contents of proposed meetings or calls 26 and research 28 and upon the performance data. As above, the performance evaluation is preferably a series of quantified numerical values calculated by the software for each of the various aspects of the proposed meetings or calls 26 and research 28 discussed above (e.g., whether or not the proposed meeting or call 26 was accepted, quality of the proposed meeting or call 26, quantity of the research 28, quality of the research 28, etc.). Again, a virtually infinite number of algorithms are possible, and many are already are known in the art, for generating quantified performance evaluations, and therefore, such algorithms are not discussed herein in detail.

As shown at block 56, the performance evaluations for each of the proposed trade ideas 24, the proposed meetings or calls 26 and the research 28 are then weighted according to weighted preferences 36 retrieved from weighted preferences storage 38, and an overall sell-side professional performance rating is calculated. As with the algorithms discussed above for generating quantified performance evaluations for each of the various types of sell-side data 22, numerous weighting algorithms and techniques will be readily apparent to one skilled in the art, and many are well-known. As such, weighting algorithms are not discussed herein in detail. However, it should be apparent that the quantified performance evaluations associated with those aspects of the various sell-side data 22 which the buy-side professional has indicated are important to him/he through the use of the weighted preferences 36 should be weighted higher than those in connection with which the buy-side professional has indicated lower or no importance.

It should also be recognized, particularly with reference to proposed trade ideas 24, that it is preferable for all proposed trade ideas 24 provided by the sell-side professional to be evaluated, regardless of whether or not they were implemented by the buy-side professional. In this manner, the skills of the sell-side professional can be evaluated without being influenced by the skill (or lack thereof) of the buy-side professional (e.g., by implementing only the proposed trade ideas 24 that failed, thereby artificially decreasing the perceived skill of the sell-side professional if only implemented proposed trade ideas 24 were evaluated, or by implementing only the proposed trade ideas 24 that succeeded, thereby artificially increasing the perceived skill of the sell-side professional if only implemented proposed trade ideas 24 were evaluated).

The present invention, therefore, provides a system which facilitates the evaluation, by buy-side professionals, of the performance of sell-side professionals with whom they do or may do business, which facilitates a determination of a value of bundled services buy-side professionals receive from sell-side professionals, which increases accountability, disclosure and transparency in the relationships between buy-side and sell-side professionals, which is based upon objective criteria, which facilitates a determination by buy-side professionals of which sell-side professionals with whom to do business, which facilitates a determination by buy-side professionals of how much sell-side professionals should be compensated, which is simple to use and does not place significant additional burdens on the buy-side professionals, and which continuously monitors and updates the evaluations of sell-side professionals.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for facilitating evaluation, by a buy-side professional, of performance of a sell-side professional, said system comprising:
a computer system;
a source of performance data in which said computer system is in communication;
software executing on said computer system for receiving from the sell-side professional a plurality of sell-side data;
software executing on said computer system for determining a performance evaluation of each of the plurality of sell-side data based at least in part upon contents of each of the plurality of sell-side data and at least in part upon the performance data;
software executing on said computer system for receiving from the buy-side professional a set of weighted preferences indicative of importance to the buy-side professional of performance of different types of sell-side data; and
software executing on said computer system for calculating a performance rating of the sell-side professional based at least in part upon the performance evaluation of each of the plurality of sell-side data and at least in part upon the set of weighted preferences.

2. The system of claim 1 further comprising software executing on said computer system for displaying the performance rating to the buy-side professional.

3. The system of claim 2 wherein the software executing on said computer system for displaying the performance rating to the buy-side professional simultaneously displays performance ratings calculated for a plurality of sell-side professionals in order to facilitate comparison of the performance of the plurality of sell-side professionals by the buy-side professional.

4. The system of claim 2 wherein the software executing on said computer system for displaying the performance rating to the buy-side professional displays a comparison of the performance rating of the sell-side professional with calculated performance ratings of a plurality of other sell-side professionals comprising a universe of alternatives available for coverage.

5. The system of claim 1 wherein at least some of the sell-side data comprise proposed trade ideas.

6. The system of claim 5:
wherein at least some of the performance data comprise data indicative of what at least one of the following would have been had each of the proposed trade ideas been implemented by the buy-side professional: relative return, risk adjusted relative return, absolute return, risk adjusted absolute return, and maximum drawdown; and
wherein the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown.

7. The system of claim 5:
wherein at least some of the performance data comprise data indicative of at least one of the following: trade uniqueness, trade focus, and concentration of returns; and
wherein the set of weighted preferences is indicative of importance to the buy-side professional of at least one of the following: trade uniqueness, trade focus, and concentration of returns.

8. The system of claim 5 wherein at least some of the proposed trade ideas comprise proposed trade ideas implemented by the buy-side professional, and wherein at least some of the proposed trade ideas comprise proposed trade ideas not implemented by the buy-side professional.

9. The system of claim 1 wherein at least some of the sell-side data comprise proposed meetings or calls.

10. The system of claim 9 wherein at least some of the performance data comprise data indicative of whether each of the proposed meetings or calls was accepted or declined by the buy-side professional, and wherein the set of weighted preferences is indicative of importance to the buy-side professional of whether each of the proposed meetings or calls was accepted or declined by the buy-side professional.

11. The system of claim 9 wherein at least some of the performance data comprise data indicative of a quality of each of the proposed meetings or calls, and wherein the set of weighted preferences is indicative of importance to the buy-side professional of the quality of each of the proposed meetings or calls.

12. The system of claim 1 wherein at least some of the sell-side data comprise research.

13. The system of claim 12 wherein at least some of the performance data comprise data indicative of a quantity of the research, and wherein the set of weighted preferences is indicative of importance to the buy-side professional of the quantity of the research.

14. The system of claim 12 wherein at least some of the performance data comprise data indicative of a quality of the research, and wherein the set of weighted preferences is indicative of importance to the buy-side professional of the quality of the research.

15. The system of claim 1 wherein said computer system comprises:
a central computer;
a buy-side computer, operable by the buy-side professional, in communication with said central computer over a first network; and
a sell-side computer, operable by the sell-side professional, in communication with said central computer over a second network.

16. The system of claim 15 wherein at least one of the first network and the second network comprises the Internet.

17. A system for facilitating evaluation, by a buy-side professional, of performance of a sell-side professional, said system comprising:
a central computer;
a buy-side computer, operable by the buy-side professional, in communication with said central computer over a first network;
a sell-side computer, operable by the sell-side professional, in communication with said central computer over a second network;
a source of performance data in which said central computer is in communication;
software executing on said central computer for receiving from said sell-side computer a plurality of sell-side data, each of the plurality of sell-side data comprising at least one of the following: proposed trade ideas, proposed meetings or calls and research;
software executing on said central computer for determining a performance evaluation of each of the plurality of sell-side data based at least in part upon contents of each of the plurality of sell-side data and at least in part upon the performance data;
software executing on said central computer for receiving from said buy-side computer a set of weighted preferences indicative of importance to the buy-side professional of performance of different types of sell-side data;
software executing on said central computer for calculating a performance rating of the sell-side professional based at least in part upon the performance evaluation of each of the plurality of sell-side data and at least in part upon the set of weighted preferences; and
software executing on said central computer for transmitting the performance rating to said buy-side computer for display to the buy-side professional.

18. The system of claim 17 wherein the software executing on said central computer for transmitting the performance rating to said buy-side computer transmits performance ratings calculated for a plurality of sell-side professionals for simultaneous display to the buy-side professional in order to facilitate comparison of the performance of the plurality of sell-side professionals by the buy-side professional.

19. The system of claim 17 wherein the software executing on said central computer for transmitting the performance rating to said buy-side computer transmits a comparison of the performance rating of the sell-side professional with calculated performance ratings of a plurality of other sell-side professionals comprising a universe of alternatives available for coverage.

20. The system of claim 17:
wherein at least some of the performance data comprise data indicative of what at least one of the following would have been had each of the proposed trade ideas been implemented by the buy-side professional: relative return, risk adjusted relative return, absolute return, risk adjusted absolute return, and maximum drawdown; and
wherein the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown.

21. The system of claim 17:
wherein at least some of the performance data comprise data indicative of at least one of the following: trade uniqueness, trade focus, and concentration of returns; and
wherein the set of weighted preferences is indicative of importance to the buy-side professional of at least one of the following: trade uniqueness, trade focus, and concentration of returns.

22. The system of claim 17 wherein at least some of the proposed trade ideas comprise proposed trade ideas implemented by the buy-side professional, and wherein at least some of the proposed trade ideas comprise proposed trade ideas not implemented by the buy-side professional.

23. The system of claim 17 wherein at least some of the performance data comprise data indicative of whether each of the proposed meetings or calls was accepted or declined by the buy-side professional, and wherein the set of weighted preferences is indicative of importance to the buy-side professional of whether each of the proposed meetings or calls was accepted or declined by the buy-side professional.

24. The system of claim 17 wherein at least some of the performance data comprise data indicative of a quality of each of the proposed meetings or calls, and wherein the set of weighted preferences is indicative of importance to the buy-side professional of the quality of each of the proposed meetings or calls.

25. The system of claim 17 wherein at least some of the performance data comprise data indicative of a quantity of the research, and wherein the set of weighted preferences is indicative of importance to the buy-side professional of the quantity of the research.

26. The system of claim 17 wherein at least some of the performance data comprise data indicative of a quality of the research, and wherein the set of weighted preferences is indicative of importance to the buy-side professional of the quality of the research.

27. The system of claim 17 wherein at least one of the first network and the second network comprises the Internet.

28. A method for facilitating evaluation, by a buy-side professional, of performance of a sell-side professional, said method comprising the steps of:
receiving a plurality of sell-side data from the sell-side professional;
receiving performance data from a source of performance data;
determining a performance evaluation of each of the plurality of sell-side data based at least in part upon contents of each of the plurality of sell-side data and at least in part upon the performance data;
receiving from the buy-side professional a set of weighted preferences indicative of importance to the buy-side professional of performance of different types of sell-side data; and
calculating a performance rating of the sell-side professional based at least in part upon the performance evaluation of each of the plurality of sell-side data and at least in part upon the set of weighted preferences.

29. The method of claim 28 further comprising the step of displaying the performance rating to the buy-side professional.

30. The method of claim 29 wherein said step of displaying the performance rating to the buy-side professional comprises the step of simultaneously displaying performance ratings calculated for a plurality of sell-side professionals in order to facilitate comparison of the performance of the plurality of sell-side professionals by the buy-side professional.

31. The method of claim 29 wherein said step of displaying the performance rating to the buy-side professional comprises the step of displaying a comparison of the performance rating of the sell-side professional with calculated performance ratings of a plurality of other sell-side professionals comprising a universe of alternatives available for coverage.

32. The method of claim 28 wherein at least some of the sell-side data comprise proposed trade ideas.

33. The method of claim 32:
wherein at least some of the performance data comprise data indicative of what at least one of the following would have been had each of the proposed trade ideas been implemented by the buy-side professional: relative return, risk adjusted relative return, absolute return, risk adjusted absolute return, and maximum drawdown; and
wherein the set of weighted preferences is indicative of importance to the buy-side professional of what at least one of the following would have been had each of the proposed trade ideas been implemented by the buy-side professional: relative return, risk adjusted relative return, absolute return, risk adjusted absolute return, and maximum drawdown.

34. The method of claim 32:
wherein at least some of the performance data comprise data indicative of at least one of the following: trade uniqueness, trade focus, and concentration of returns; and
wherein the set of weighted preferences is indicative of importance to the buy-side professional of at least one of the following: trade uniqueness, trade focus, and concentration of returns.

35. The method of claim 32 wherein at least some of the proposed trade ideas comprise proposed trade ideas implemented by the buy-side professional, and wherein at least some of the proposed trade ideas comprise proposed trade ideas not implemented by the buy-side professional.

36. The method of claim 28 wherein at least some of the sell-side data comprise proposed meetings or calls.

37. The method of claim 36 wherein at least some of the performance data comprise data indicative of whether each of the proposed meetings or calls was accepted or declined by the buy-side professional, and wherein the set of weighted preferences is indicative of importance to the buy-side professional of whether each of the proposed meetings or calls was accepted or declined by the buy-side professional.

38. The method of claim 36 wherein at least some of the performance data comprise data indicative of a quality of each of the proposed meetings or calls, and wherein the set of weighted preferences is indicative of importance to the buy-side professional of the quality of each of the proposed meetings or calls.

39. The method of claim 28 wherein at least some of the sell-side data comprise research.

40. The method of claim 39 wherein at least some of the performance data comprise data indicative of a quantity of the research, and wherein the set of weighted preferences is indicative of importance to the buy-side professional of the quantity of the research.

41. The method of claim 39 wherein at least some of the performance data comprise data indicative of a quality of the research, and wherein the set of weighted preferences is indicative of importance to the buy-side professional of the quality of the research.
